(19) United States
(12) Patent Application Publication
(10) Pub. No.: US 2010/0304005 A1
(43) Pub. Date: Dec. 2, 2010

(54) POURING SPOON FOR PRODUCING LAYERED BEVERAGES

(75) Inventor: James M. Beale, Brownsville, TX (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: JMB Brewcraft LLC

(21) Appl. No.: 12/789,329

(22) Filed: May 27, 2010

Related U.S. Application Data
(60) Provisional application No. 61/181,748, filed on May 28, 2009.

(51) Int. Cl. A47J 31/44; A47G 21/04

(52) U.S. Cl. 426/665; 30/327

(57) ABSTRACT

A pouring spoon (301) is provided which comprises a bowl (303) and a handle attached to said bowl. The handle has first (321), second (323) and third (325) segments, wherein said second segment is attached to said first segment by way of a first bend (322), wherein said second segment is attached to said third segment by way of a second bend (324), and wherein said third segment is attached to said bowl by way of a third bend (326).

### CROSS-REFERENCE TO RELATED APPLICATIONS

This application claims the benefit of priority from U.S. Provisional Application Ser. No. 61/181,748, filed May 28, 2009, having the same title, and having the same inventor, and which is incorporated herein by reference in its entirety.

### FIELD OF THE DISCLOSURE

The present disclosure relates generally to bartending utensils, and more particularly to pouring spoons for making layered beverages.

### BACKGROUND OF THE DISCLOSURE

Various layered beverages are known to the art. One of the most popular beverages of this type is the Black and Tan, which features a layer of dark beer (typically a stout or porter, and traditionally GUINNESS® stout) over a layer of ale (typically a pale ale, and traditionally BASS® ale). Since the nearly black stout and the copper-colored pale ale have different densities, when properly poured, the beers will layer on top of each other to create a beverage with a dramatic appearance. Other well-known layered beverages, and the ingredients traditionally used to make them, are set forth in TABLE 1 below:

| Name | Top Ingredient | Bottom Ingredient |
|---|---|---|
| Big Easy | BEAMISH ® Stout | ABITA ® Amber Lager |
| Black & Blue | Murphy's ® Stout | BAR HARBOR ® Blueberry |
| | | Ale |
| Black & Tan | GUINNESS ® Stout | BASS ® Ale |
| Black Castle | GUINNESS ® Stout | NEW CASTLE ® Ale |
| Black Cherry | GUINNESS ® Stout | SAMUEL ADAMS ® Cherry |
| | | Wheat |
| Black Velvet | GUINNESS ® Stout | Champagne |
| Blacksmith | GUINNESS ® Stout | SMITHWICK'S ® Ale |
| Blacktop | BEAMISH ® Stout | FAT TIRE ® Amber Ale |
| Bohemian | BEAMISH ® Stout | PILSNER URQUELL ® |
| Bumble Bee | Murphy's ® Stout | DUNDEE ® Honey Lager |
| Dark & | GUINNESS ® Stout | ANCHOR STEAM ® |
| Steamy | | |
| Dirty Turtle | GUINNESS ® Stout | TERRAPIN ® Rye Pale Ale |
| Eclipse | GUINNESS ® Stout | BLUE MOON ® |
| Half & Half | GUINNESS ® Stout | HARP ® Lager |
| Patriot | GUINNESS ® Stout | SAM ADAMS ® Lager |
| Snakebite | GUINNESS ® Stout | Hard Cider |
| Snapper | Murphy's ® Stout | REDHOOK ESB ® |

In order to achieve the layered effect that these beverages are popular for, it is important to add the ingredients with a minimum amount of mixing. This is typically accomplished through the use of a pouring spoon. On example of a prior art pouring spoon is depicted in FIGS. 1-3.

The pouring spoon 101 depicted therein comprises a bowl 103 approximately 1.75 inches in diameter which is attached to a handle 105 about 4.25 inches in length. The handle has a crook 107 therein in proximity to the bowl. The pouring spoon 101 is further equipped with a chain 109 which extends through a hole 111 in the handle 105 for storage purposes.

FIGS. 4-5 depict the use of the pouring spoon of FIGS. 1-3 in preparing a Black and Tan in a pint glass 113. The pint glass 113 is first filled approximately half way with BASS® ale. The pouring spoon 101 is then positioned such that the hook 107 is mounted on the lip of the glass 113 in the manner shown in FIG. 4, after which the GUINNESS® Stout is poured over the back of the spoon 101 such that it fans out over the ale and creates a dividing line between the two beers. The result is the layered beverage shown in FIG. 5.

### BRIEF DESCRIPTION OF THE DRAWINGS

FIG. 1 is a perspective view of a prior art pouring spoon.

FIG. 2 is a side view of a prior art pouring spoon.

FIG. 3 is a perspective view of a prior art pouring spoon.

FIG. 4 is a perspective view depicting the mounting of a prior art pouring spoon on a pint glass as it appears prior to pouring.

FIG. 5 is a perspective view depicting the mounting of a prior art pouring spoon on a pint glass as it appears after pouring.

FIG. 6 is a perspective view of a prior art pouring spoon.

FIG. 7 is a top view and a side view of a first embodiment of a pouring spoon made in accordance with the teachings herein, and shown in its initial stamped form.

FIG. 8 is a side view of the pouring spoon of FIG. 7, shown in its final shaped form.

FIG. 9 is an illustration of the use of the pouring spoon of FIG. 8 in making a layered beverage.

FIG. 10 is an illustration of the use of the pouring spoon of FIG. 8 in making a layered beverage.

FIG. 11 is a perspective view of the pouring spoon of FIG. 8.

FIG. 12 is a top view of the bowl of a second embodiment of a pouring spoon made in accordance with the teachings herein.

### SUMMARY OF THE DISCLOSURE

In one aspect, a pouring spoon is provided which comprises a bowl and a handle attached to said bowl. The handle has first, second and third segments, wherein said second segment is attached to said first segment by way of a first bend, wherein said second segment is attached to said third segment by way of a second bend, and wherein said third segment is attached to said bowl by way of a third bend.

In another aspect, a method for preparing a layered beverage is provided. The method comprises (a) providing a spoon comprising a bowl having a handle attached thereto, wherein said handle has first, second and third segments, wherein said second segment is attached to said first segment by way of a first bend, wherein said second segment is attached to said third segment by way of a second bend, and wherein said third segment is attached to said bowl by way of a third bend; (b) partially filling a container with a first beverage, wherein said container has a rim; (c) positioning said spoon with respect to said container such that said second bend extends over the rim of said container; and (d) pouring a second beverage over the bowl of said spoon.

### DETAILED DESCRIPTION

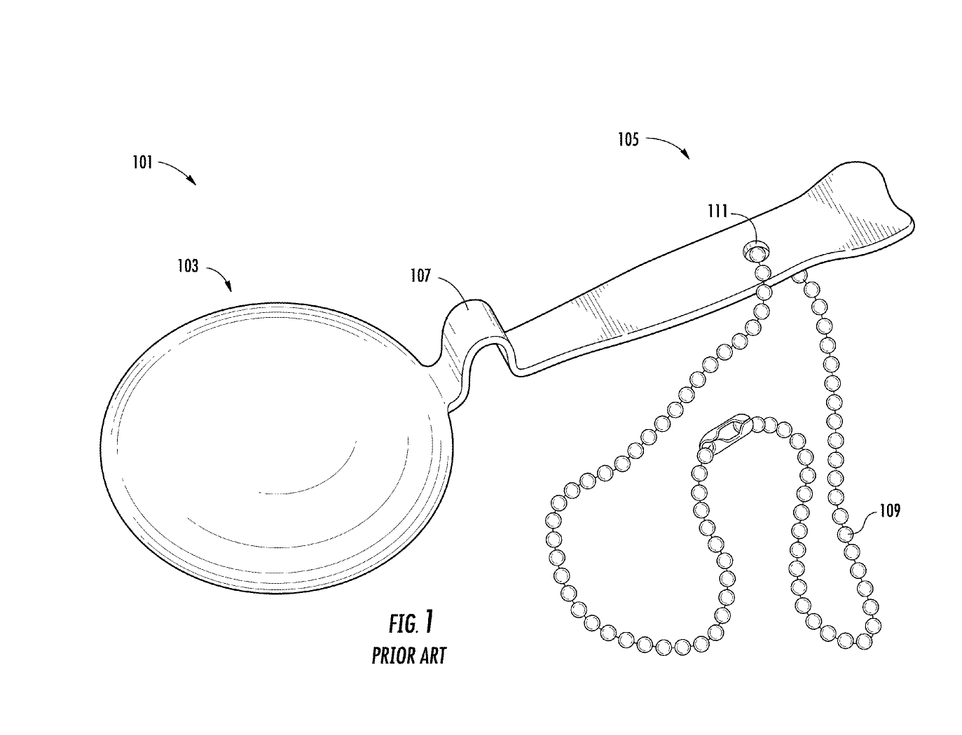

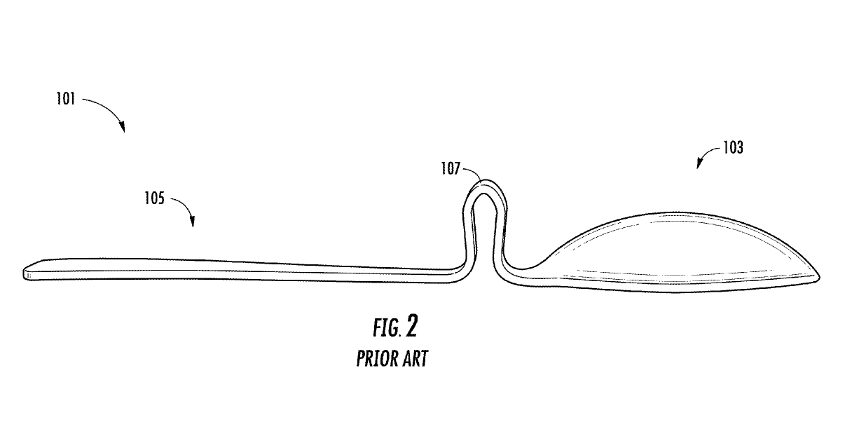

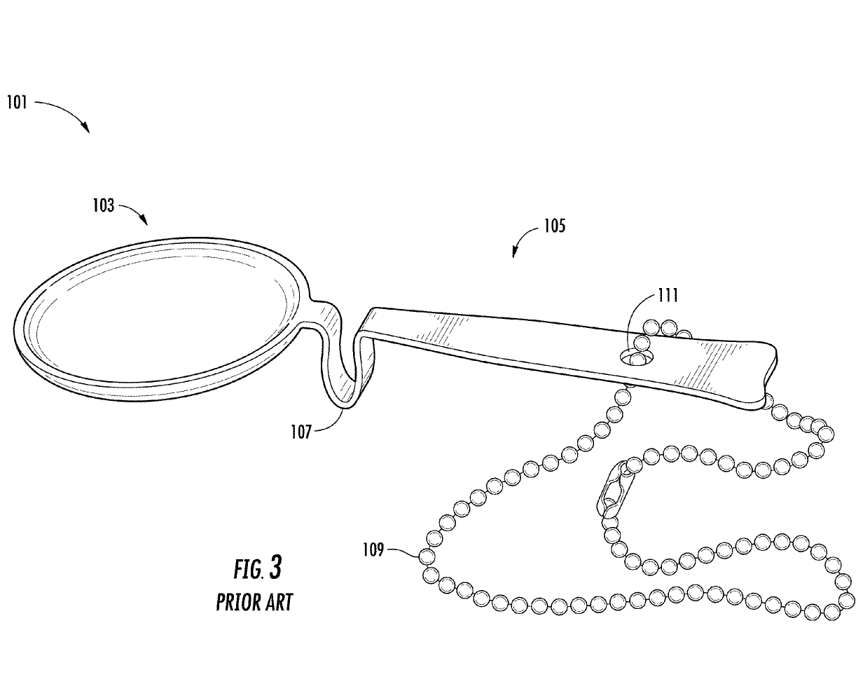

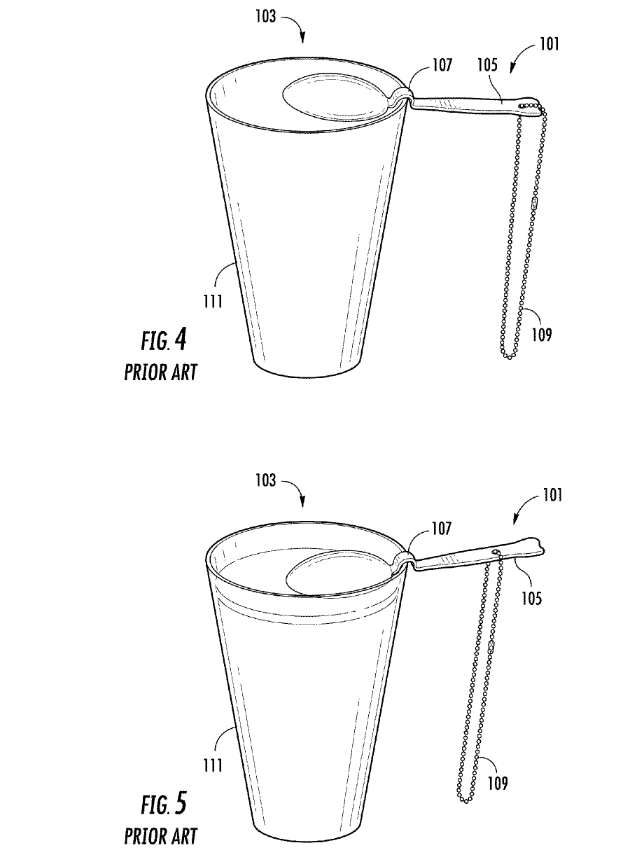

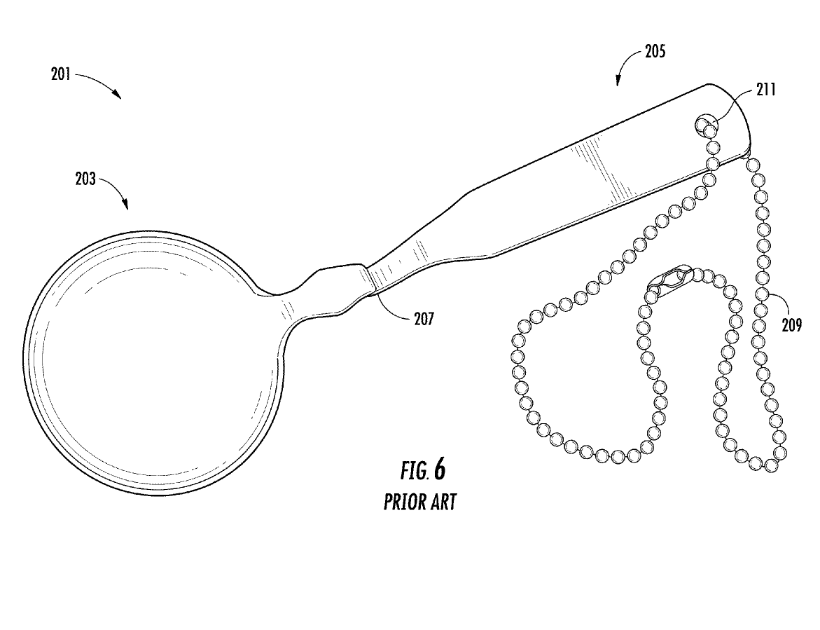

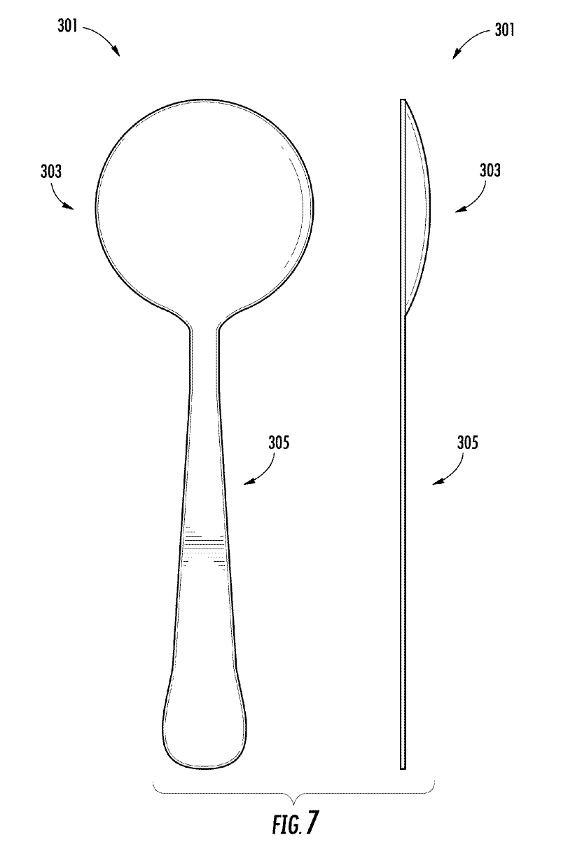

While the pouring spoons of FIGS. 1-6 may have some beneficial features, the use of these spoons requires a significant amount of skill and training on the part of the user in order to produce a layered beverage in which the individual layers remain segregated and sharply defined. Frequently, the use of these pouring spoons in the hands of a less skilled user results in a beverage in which the individual layers become partially or fully mixed during the pouring process. In particular, pouring spoons of this type are designed to rest on the lip of a glass, and require the second beverage component to flow across the bowl of the spoon and then drop down into the glass on top of a layer of the first beverage component. This mode of operation requires a very slow and careful pour of the second beverage component in order to avoid mixing during the pouring process. Consequently, the preparation of these beverages requires a bartender's full attention, and is a frequent bottleneck at establishments where such beverages are served.

There is thus a need in the art for an improved pouring spoon that is easy to use and that is less dependent on the skill of the user to produce desirable results. There is further a need in the art for a method for preparing layered beverages that allows for faster pouring of the component beverages without disrupting the layered structure of the beverage, and that does not require the full attention of the bartender during the pouring process, thus facilitating multitasking.

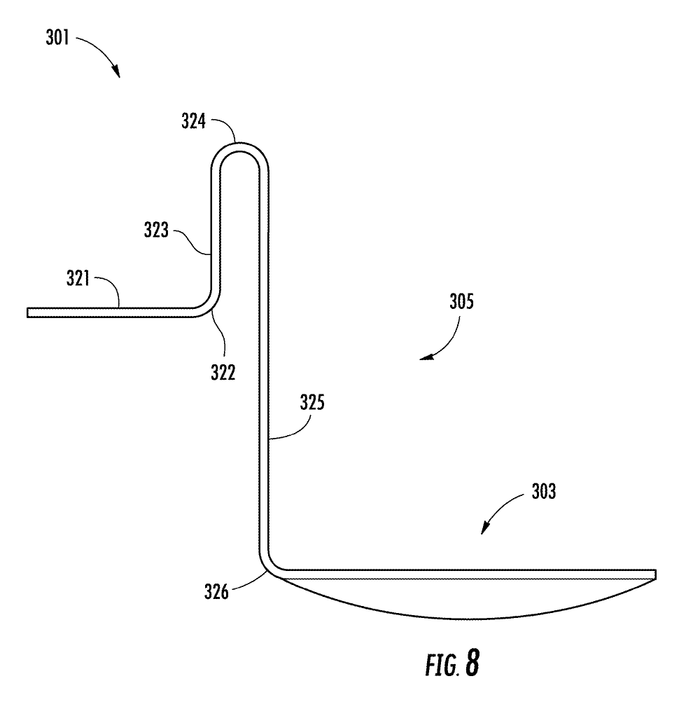

It has now been found that the foregoing needs may be met with the pouring spoons disclosed herein, a first particular, non-limiting embodiment of which is disclosed in FIGS. 7-10. With reference to FIG. 7, the pouring spoon 301 shown therein is depicted in its initial stamped form (that is, before bending). The pouring spoon 301 in this particular embodiment is made from stainless steel, is about 7.25 inches in total length, and comprises a rounded bowl 303 about 2.3 inches in diameter and about 0.23 inches in depth. The pouring spoon 301 is equipped with a handle 305 about 4.75 inches in length.

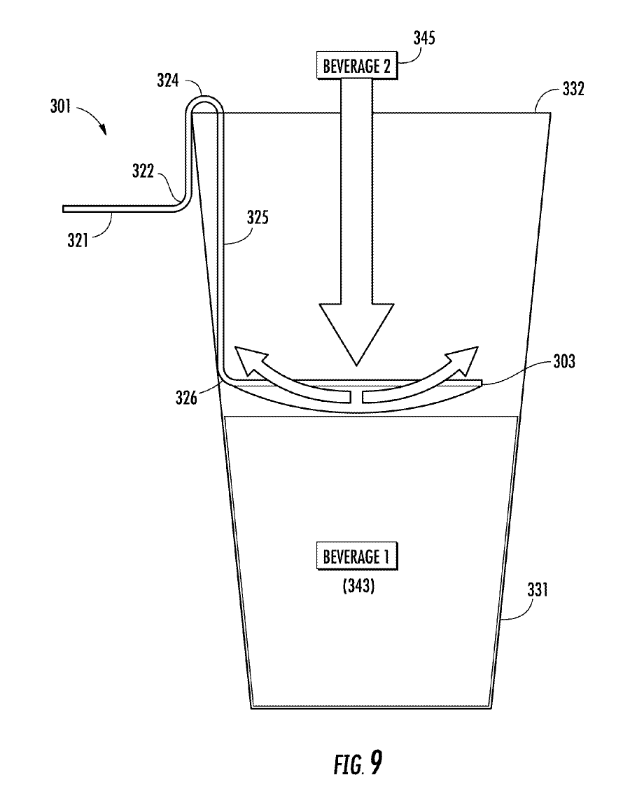

The pouring spoon 301 in FIG. 7 is subsequently bent in the three places indicated to produce the final configuration depicted in FIG. 8. In the final configuration, the handle 305 of the pouring spoon 301 comprises a first segment 321 approximately 1 inch in length which is essentially parallel to the plane of the bowl 303, a second segment 323 approximately 0.75 inches in length, and a third segment 325 of approximately 2.375 inches in length. The first segment 321 is attached to the second segment 323 by way of a first bend 322 having a curvature of essentially 90°. The third segment 325 is joined on one end to the second segment 323 by way of a second bend 324 having a curvature of essentially 180°, and is joined on the other end to the bowl 303 by way of a third bend 326 having a curvature of essentially 90°.

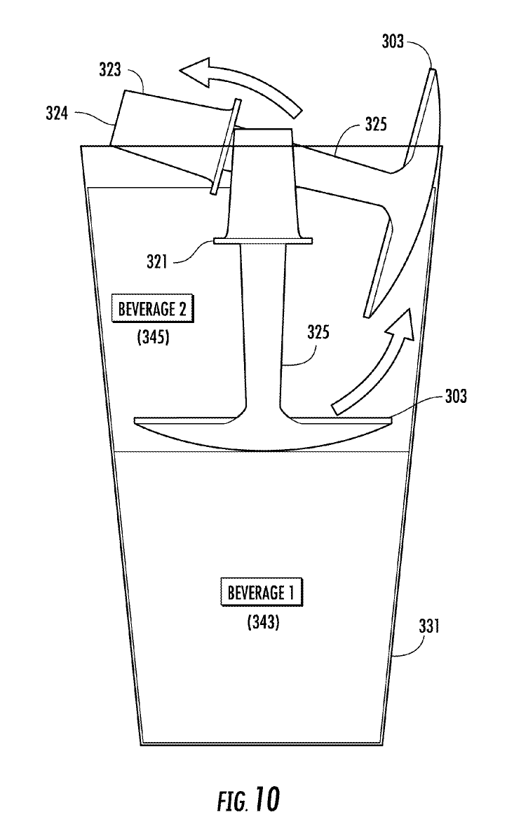

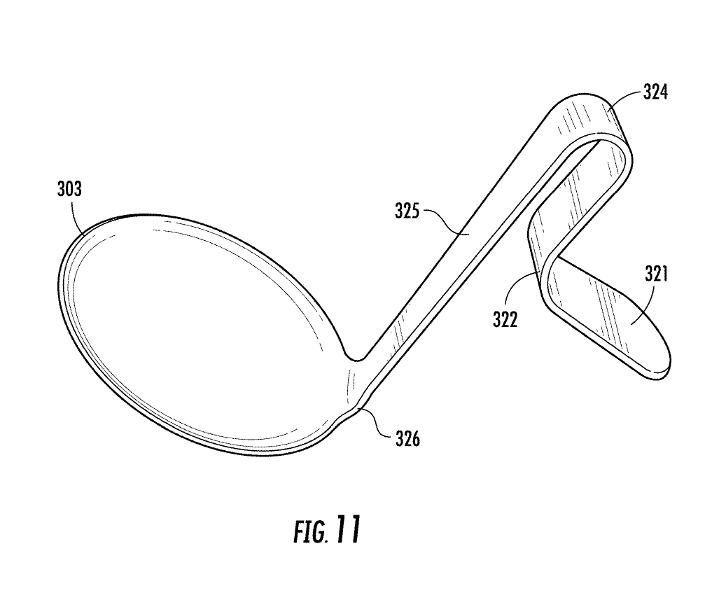

The methodology by which the pouring spoon of FIGS. 7-8 may be utilized to produce a layered beverage is indicated in FIGS. 9-10, which demonstrate the use of the pouring spoon 301 in creating a Black and Tan. As seen in FIG. 9, the first beverage 343 (in this case, a pale ale) is used to fill a pint glass 341 of standard dimensions approximately half way, after which the pouring spoon 301 is situated such that the second bend 324 is seated on the rim 332 of the glass 331. In this position, the bowl 303 of the spoon 301 will extend just above the surface of the first beverage 343, with the concave surface of the bowl 303 facing upwards. Also, in this position, one end of the third segment 325 of the pouring spoon 301 in the vicinity of the third bend 326 presses against the inner surface of the glass 331, thereby stabilizing the spoon 331 during the pouring process.

After the pouring spoon 301 is situated on the glass 331, the second beverage 345 is then poured onto the concave surface of the bowl 303. As indicated by the arrows, this causes the second beverage 345 to fan outwards and slightly upwards. Consequently, the initial momentum of the second beverage 345 along a vertical axis (i.e., an axis perpendicular to the center of the bowl) is diminished as compared to the situation experienced with the pouring spoon of FIGS. 1-3, both because the bowl 303 of the pouring spoon 301 of FIG. 8 sits closer to the surface of the first beverage 343 than the bowl 103 of the pouring spoon 101 of FIGs. 103, and because the second beverage 345 is poured across a concave surface with the pouring spoon 301 of FIG. 8, as opposed to a convex surface as is the case with the pouring spoon 101 of FIGS. 1-3.

As a result of the foregoing, the use of the pouring spoon 301 requires less skill to achieve a properly layered beverage than the use of a conventional pouring spoon 101. Moreover, the use of the pouring spoon 301 allows the layered beverage components to be poured faster (e.g., with a full open tap), and does not require constant attention from the bartender during the pouring process. Therefore, the bartender can complete other tasks during the pouring process, thus removing the preparation of layered beverages as a typical bottleneck in drinking establishments.

After pouring of the second beverage 345 is complete, the spoon 301 is removed by pivoting it about an axis which is parallel to the surface of the second beverage 345 as indicated in FIG. 10. Notably, the length of the third segment 325 is selected such that, as the spoon 301 pivots, the bowl 303 rides smoothly up the side of the glass 331 without coming into contact with it, or only coming into glancing contact with it. This method of removal of the spoon 301, which is facilitated by the dimensions of the first segment 321, minimizes mixing between the beverage layers 343 and 345.

Preferably, the first segment has a length within the range of about 0.5 inches to about 1.5 inches, more preferably, the first segment has a length within the range of about 0.75 inches to about 1.25 inches, and most preferably, the first segment has a length within the range of about 0.9 inches to about 1.2 inches. Preferably, the first segment has a minimum width within the range of about 7/16 inches to about 15/16 inches, more preferably, the first segment has a minimum width within the range of about 9/16 inches to about 13/16 inches, and most preferably, the first segment has a minimum width within the range of about 10/16 inches to about 1 and 2/16 inches. Preferably, the first segment has a maximum width within the range of about 10/16 inches to about 1 and 2/16 inches, more preferably, the first segment has a maximum width within the range of about 12/16 inches to about 1 inches, and most preferably, the first segment has a maximum width of about ⅞ inches.

A further notable feature of the pouring spoon 301 of FIG. 8 relates to the width of the handle 305 at the third)(90° bend 326. Preferably, the width of the handle at this location is sufficiently large to stabilize the spoon 301 (i.e., to prevent excessive lateral movement thereof) during pouring. Typically, this width is at least about 0.25 inches, preferably at least about 0.30 inches, more preferably within the range of about 0.30 inches to about 0.75 inches, and most preferably within the range of about 0.30 inches to about 0.5 inches.

In the preferred embodiment, the bowl 303 of the pouring spoon 301 is essentially circular. In this embodiment, the bowl has a diameter which is typically within the range of about 1 to about 3 inches, preferably within the range of about 1.25 to about 2.5 inches, more preferably within the range of about 2 to about 2.5 inches, and most preferably is about 2.3 inches in diameter.

The bowl 303 of the pouring spoon 301 has a maximum depth which is typically within the range of about 0.1 to about 1 inches, preferably within the range of about 0.1 to about 0.5 inches, and more preferably within the range of about 0.15 to about 0.3 inches. Most preferably, bowl 303 of the pouring spoon 301 has a maximum depth of about 0.23 inches.

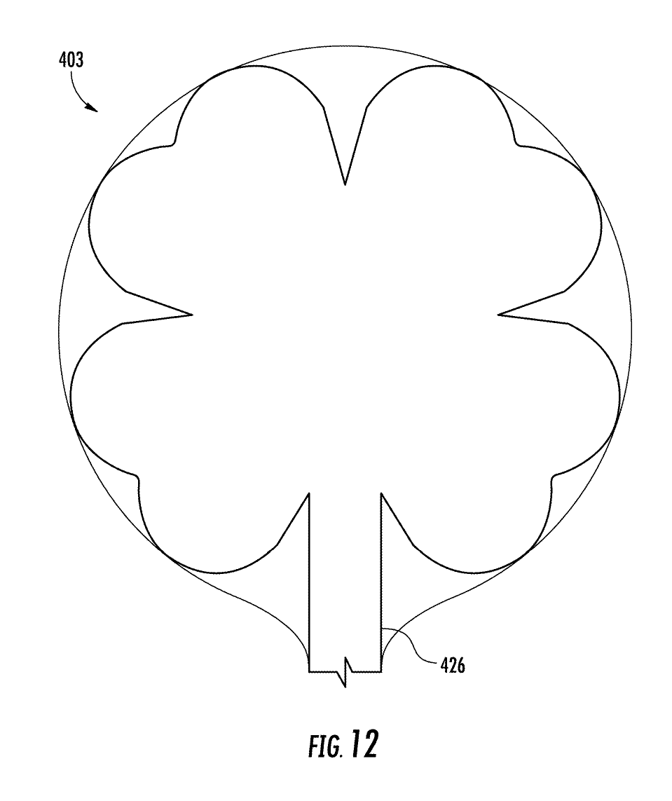

With reference to FIG. 12, a second particular, non-limiting embodiment of a pouring spoon is depicted which is made in accordance with the teachings herein. Only the bowl 403 and third bend 426 of this embodiment is depicted, the remaining features being similar to those described with respect to the first embodiment shown above and depicted in FIGS. 7-11. In the particular embodiment depicted, the bowl 403 is in the general shape of a four-leaf clover. The outermost points of the clover leaves fall on a circle having a diameter of about 2.3 inches. The bowl 403 is preferably concave upward in a manner similar to the first embodiment described above. In some variations of this embodiment, the four-leaf clover may be embossed or engraved into the surface of a bowl similar to that shown in the first embodiment.

Various modifications may be made to the design and construction of the pouring spoon described herein without departing from the scope of the present disclosure. For example, in some embodiments, one or more of the first, second and third bends may be replaced with flat segments, facets, angles, or other shapes which may allow the pouring spoon to mate or register with the surface features of a glass or other beverage container. In some embodiments, one or more of the first, second and third bends may be flared or provided with suitable tabs or protrusions to impart greater stability or resistance to movement of the pouring spoon. The edge of the spoon may also be beveled, rounded, or flat.

Various materials may be used in the construction of the pouring spoon described herein. Preferably, the pouring spoon comprises a suitable metal or metal alloy which is durable and safe for use with beer and other beverages. Some non-limiting examples of such metals or metal alloys include stainless steel, pewter, copper, silver, tin or aluminum. In some embodiments, the pouring spoon may comprise a base material comprising a first metal or metal alloy which is plated with a second metal or metal alloy.

Embodiments of the spoon are possible which comprise various other materials, such as plastics, polymeric materials, fibrous materials, wood, glass, or combinations of the foregoing. These materials may contain, where suitable, various fillers, dyes, pigments, or surface treatments to render them more suitable for the present application or to make them more aesthetically appealing.

Preferably, the second segment and the third segment are aligned such that the axes of these segments are coplanar. However, in some embodiments, the second segment may be offset from the third segment. In such embodiments, the angle formed by the axis of the third segment to the plane containing the axes of the first and second segments will typically be no more than about 90°, and will preferably be within the range of about 5° to about 90°, more preferably be within the range of about 10° to about 60°, even more preferably be within the range of about 15° to about 40°, and most preferably be within the range of about 15° to about 30°.

The bowl utilized in the pouring spoons disclosed herein may have various shapes. Preferably, the bowl is rounded and concave upward (when the pouring spoon is positioned in a glass for use) and has a circumference that is circular or elliptical. However, embodiments are possible in accordance with the teachings herein in which the bowl has various other shapes. For example, the bowl may have a circumference that is square, rectangular, pentagonal, hexagonal, or of any other polygonal shape. The circumference of the bowl may also be irregular in shape or may contain various combinations of straight or rounded edges. By way of example, the bowl may be provided with a profile in the shape of a four-leaf clover as shown in the embodiment depicted in FIG. 12, which is described in greater detail below. In some embodiments, the bowl may also be provided with a circumferential lip which may have various profile but which is preferably of uniform width about the circumference of the bowl.

The interior surface of the bowl preferably essentially lies on a single hemisphere or hemi-ellipsoid. In some embodiments, however, the interior surface of the bowl may contain at least a first portion which essentially lies on a first hemisphere or hemi-ellipsoid, and a second portion which essentially lies on a second hemisphere or hemi-ellipsoid. In other embodiments, the interior surface of the bowl may contain various indentations or raised surfaces to impart a decorative surface thereto or to aid in or enhance flow or the directionality thereof.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

### APPENDIX A

### Claimable Subject Matter Listing

The following is a listing of some of the potentially claimable subject matter in the present application, it being understood that the subject matter currently being claimed is defined solely by the claims listing above.

A1. A pouring spoon, comprising:

a bowl; and

a handle attached to said bowl, said handle having first, second and third segments, wherein said second segment is attached to said first segment by way of a first bend, wherein said second segment is attached to said third segment by way of a second bend, and wherein said third segment is attached to said bowl by way of a third bend.

A2. The pouring spoon of claim A1, wherein the lip of said bowl lies within a plane which is essentially perpendicular to said third segment.
A3. The pouring spoon of claim A1, wherein the upper lip of said bowl lies within a plane which intersects said third segment at an angle within the range of about 75° to about 105°.
A4. The pouring spoon of claim A1, wherein the upper lip of said bowl lies within a plane which intersects said third segment at an angle within the range of about 80° to about 100°.
A5. The pouring spoon of claim A1, wherein said bowl is concave in the direction of a vector extending from said third bend to said second bend.
A6. The pouring spoon of claim A1, wherein said first segment is essentially perpendicular to said second segment.

### APPENDIX A

### Cont.

A7. The pouring spoon of claim A1, wherein said first bend is within the range of about 75° to about 105°.
A8. The pouring spoon of claim A1, wherein said first bend is within the range of about 80° to about 100°.
A9. The pouring spoon of claim A1, wherein said second bend is within the range of about 165° to about 195°.
A10. The pouring spoon of claim A1, wherein said second bend is within the range of about 170° to about 190°.
A11. The pouring spoon of claim A1, wherein the distance between said second bend and said third bend is within the range of about 1.5 inches to about 3.5 inches.
A12. The pouring spoon of claim A1, wherein the distance between said second bend and said third bend is within the range of about 2 inches to about 3 inches.
A13. The pouring spoon of claim A1, wherein the distance between said second bend and said third bend is within the range of about 2.25 inches to about 2.5 inches.
A14. The pouring spoon of claim A1, in combination with a pint glass.
A15. The pouring spoon of claim A11, wherein the distance between said first bend and said second bend is within the range of about 0.5 inches to about 1.0 inches.
A16. The pouring spoon of claim A11, wherein the distance between said first bend and said second bend is within the range of about 0.60 inches to about 0.85 inches.
A17. The pouring spoon of claim A1, wherein said first segment has a length within the range of about 0.5 inches to about 1.5 inches.
A18. The pouring spoon of claim A1, wherein said first segment has a length within the range of about 0.75 inches to about 1.25 inches.
A19. The pouring spoon of claim A1, wherein said first segment has a length within the range of about 0.9 inches to about 1.2 inches.
A20. The pouring spoon of claim A1, wherein said first segment has a minimum width within the range of about 7/16 inches to about 15/16 inches.
A21. The pouring spoon of claim A1, wherein said first segment has a minimum width within the range of about 9/16 inches to about 13/16 inches.
A22. The pouring spoon of claim A1, wherein said first segment has a maximum width within the range of about 10/16 inches to about 1 and 2/16 inches.
A23. The pouring spoon of claim A1, wherein said first segment has a maximum width within the range of about 12/16 inches to about 1 inch.
A24. The pouring spoon of claim A1, wherein said first segment is adapted to be grasped.
B1. A method for preparing a layered beverage, comprising:

providing a spoon comprising a bowl having a handle attached thereto, wherein said handle has first, second and third segments, wherein said second segment is attached to said first segment by way of a first bend, wherein said second segment is attached to said third segment by way of a second bend, and wherein said third segment is attached to said bowl by way of a third bend;

partially filling a container with a first beverage, wherein said container has a rim;

positioning said spoon with respect to said container such that said second bend extends over the rim of said container; and

pouring a second beverage over the bowl of said spoon.

B2. The method of claim B1, wherein said bowl has a lip which lies within a plane which is essentially perpendicular to said third segment.
B3. The method of claim B1, wherein the upper lip of said bowl lies within a plane which intersects said third segment at an angle within the range of about 75° to about 105°.
B4. The method of claim B1, wherein the upper lip of said bowl lies within a plane which intersects said third segment at an angle within the range of about 80° to about 100°.
B5. The method of claim B1, wherein said bowl is concave in the direction of a vector extending from said third bend to said second bend.
B6. The method of claim B1, wherein said first segment is essentially perpendicular to said second segment.
B7. The method of claim B1, wherein said first bend is within the range of about 75° to about 105°.
B8. The method of claim B1, wherein said first bend is within the range of about 80° to about 100°.
B9. The method of claim B1, wherein said second bend is within the range of about 165° to about 195°.
B10. The method of claim B1, wherein said second bend is within the range of about 170° to about 190°.
B11. The method of claim B1, wherein the distance between said second bend and said third bend is within the range of about 1.5 inches to about 3.5 inches.
B12. The method of claim B1, wherein the distance between said second bend and said third bend is within the range of about 2 inches to about 3 inches.
B13. The method of claim B1, wherein the distance between said second bend and said third bend is within the range of about 2.25 inches to about 2.5 inches.
B14. The method of claim B1, in combination with a pint glass.
B15. The method of claim B11, wherein the distance between said first bend and said second bend is within the range of about 0.5 inches to about 1.0 inches.
B16. The method of claim B11, wherein the distance between said first bend and said second bend is within the range of about 0.60 inches to about 0.85 inches.
B17. The method of claim B1, wherein said first segment has a length within the range of about 0.5 inches to about 1.5 inches.
B18. The method of claim B1, wherein said first segment has a length within the range of about 0.75 inches to about 1.25 inches.
B19. The method of claim B1, wherein said first segment has a length within the range of about 0.9 inches to about 1.2 inches.
B20. The method of claim B1, wherein said first segment has a minimum width within the range of about 7/16 inches to about 15/16 inches.
B21. The method of claim B1, wherein said first segment has a minimum width within the range of about 9/16 inches to about 13/16 inches.
B22. The method of claim B1, wherein said first segment has a maximum width within the range of about 10/16 inches to about 1 and 2/16 inches.
B23. The method of claim B1, wherein said first segment has a maximum width within the range of about 12/16 inches to about 1 inches.
B24. The method of claim B1, wherein said first segment is adapted to be grasped.

What is claimed is:

1. A method for preparing a layered beverage, comprising:
providing a spoon comprising a bowl having a handle attached thereto, wherein said handle has first, second and third segments, wherein said second segment is attached to said first segment by way of a first bend, wherein said second segment is attached to said third segment by way of a second bend, and wherein said third segment is attached to said bowl by way of a third bend;
partially filling a container with a first beverage, wherein said container has a rim;
positioning said spoon with respect to said container such that said second bend extends over the rim of said container; and
pouring a second beverage over the bowl of said spoon.

2. The method of claim 1, wherein said bowl has a lip which lies within a plane which is essentially perpendicular to said third segment.

3. The method of claim 1, wherein the upper lip of said bowl lies within a plane which intersects said third segment at an angle within the range of about 75° to about 105°.

4. The method of claim 1, wherein the upper lip of said bowl lies within a plane which intersects said third segment at an angle within the range of about 80° to about 100°.

5. The method of claim 1, wherein said bowl is concave in the direction of a vector extending from said third bend to said second bend.

6. The method of claim 1, wherein said first segment is essentially perpendicular to said second segment.

7. The method of claim 1, wherein said first bend is within the range of about 75° to about 105°.

8. The method of claim 1, wherein said first bend is within the range of about 80° to about 100°.

9. The method of claim 1, wherein said second bend is within the range of about 165° to about 195°.

10. The method of claim 1, wherein said second bend is within the range of about 170° to about 190°.

11. The method of claim 1, wherein the distance between said second bend and said third bend is within the range of about 1.5 inches to about 3.5 inches.

12. The method of claim 1, wherein the distance between said second bend and said third bend is within the range of about 2 inches to about 3 inches.

13. The method of claim 1, wherein the distance between said second bend and said third bend is within the range of about 2.25 inches to about 2.5 inches.

14. The method of claim 1, wherein said container is a pint glass.

15. The method of claim 11, wherein the distance between said first bend and said second bend is within the range of about 0.5 inches to about 1.0 inches.

16. The method of claim 11, wherein the distance between said first bend and said second bend is within the range of about 0.60 inches to about 0.85 inches.

17. The method of claim 1, wherein said first segment has a length within the range of about 0.5 inches to about 1.5 inches.

18. The method of claim 1, wherein said first segment has a length within the range of about 0.75 inches to about 1.25 inches.

19. The method of claim 1, wherein said first segment has a length within the range of about 0.9 inches to about 1.2 inches.

20. The method of claim 1, wherein said first segment has a minimum width within the range of about 7/16 inches to about 15/16 inches.

21. The method of claim 1, wherein said first segment has a minimum width within the range of about 9/16 inches to about 13/16 inches.

22. The method of claim 1, wherein said first segment has a maximum width within the range of about 10/16 inches to about 1 and 2/16 inches.

23. The method of claim 1, wherein said first segment has a maximum width within the range of about 12/16 inches to about 1 inches.

24. A pouring spoon, comprising:
a bowl; and
a handle attached to said bowl, said handle having first, second and third segments, wherein said second segment is attached to said first segment by way of a first bend, wherein said second segment is attached to said third segment by way of a second bend, and wherein said third segment is attached to said bowl by way of a third bend.
